(19) United States
(12) Patent Application Publication
(10) Pub. No.: US 2015/0262069 A1
(43) Pub. Date: Sep. 17, 2015

(54) AUTOMATIC TOPIC AND INTEREST BASED CONTENT RECOMMENDATION SYSTEM FOR MOBILE DEVICES

(71) Applicant: Delvv, Inc., Palo Alto, CA (US)

(72) Inventors: Raefer Gabriel, Palo Alto, CA (US); Felice Gabriel, Palo Alto, CA (US)

(21) Appl. No.: 14/645,358

(22) Filed: Mar. 11, 2015

Related U.S. Application Data
(60) Provisional application No. 61/950,948, filed on Mar. 11, 2014.
(60) Provisional application No. 61/950,956, filed on Mar. 11, 2014.

(51) Int. Cl. G06N 5/04; G06F 17/30

(52) U.S. Cl. CPC G06N 5/047; G06F 17/30864

(57) ABSTRACT

Disclosed are techniques for automatically performing topic and interest based content recommendation for mobile devices, which can help the users of mobile computing devices (e.g., smart phones) discover more of the information they want by delivering educated recommendations that are personalized to their interests, in ways that are more natural and comprehensible. More specifically, in some embodiments, techniques described herein include a topic and interest based content recommendation system, which may include several components, such as an automated recommendation server for content available on the Internet (e.g., webpages, applications, and events), and a mobile personalization application which may retrieve various types of data and user inputs from a mobile device, and may present content recommendation to the user (e.g., upon receiving such recommendation from the server).

### RELATED APPLICATIONS

This application claims the benefit of U.S. Provisional Patent Application No. 61/950,948, entitled “DEEPLY PERSONALIZED, INTEREST-DRIVEN SMARTPHONE RECOMMENDER,” filed on Mar. 11, 2014; and U.S. Provisional Patent Application No. 61/950,956, entitled “SOCIAL MEDIA MODULATION OF MOBILE PERSONALIZATION DATA,” filed on Mar. 11, 2014; both of which are incorporated by reference herein in their entireties.

### COPYRIGHT NOTICE

A portion of the disclosure of this patent document contains material that is subject to copyright protection. The copyright owner has no objection to the facsimile reproduction by anyone of the patent document or the patent disclosure, as it appears in the United States Patent and Trademark Office patent files or records, but otherwise reserves all copyright rights whatsoever. The following notice applies to the software and data as described below and in the drawings that form a part of this document: Copyright 2015, Delvv, Inc., All Rights Reserved.

### TECHNICAL FIELD

Embodiments of the present disclosure relate to automated data analysis machines, and more particularly, to automated topic and interest based content recommendation system for mobile devices.

### BACKGROUND

In today's busy world, users find themselves bombarded with information that often is not relevant or interesting to them. With the pervasiveness of the Internet, a vast amount of information sourced from all forms of web-based media services exposes the users to what is culminated as an information overload, causing difficulty for a person to understand or digest the information. Indeed, many individuals nowadays simply have too many Tweets, Facebook posts, local event listings and news sites available, and not enough time to read them all in a meaningful way.

Therefore, it is desirable to have a tool that effectively addresses the information overload, and especially for users of mobile computing devices (e.g., smart phones).

### BRIEF DESCRIPTION OF THE DRAWINGS

The present embodiments are illustrated by way of example and are not intended to be limited by the figures of the accompanying drawings. The same reference numbers and any acronyms identify elements or acts with the same or similar structure or functionality throughout the drawings and specification for ease of understanding and convenience.

FIG. 1 illustrates an environment within which the content recommendation system introduced here can be implemented.

FIG. 2 illustrates an abstract functional diagram showing a mobile personalization application being implemented on a mobile device in accordance with some embodiments.

FIGS. 3A and 3B illustrate abstract functional diagrams showing components in a personalization modeling and content recommendation server in accordance with some embodiments.

FIG. 4 illustrates a flow chart showing a technique for cold start topic inference in accordance with some embodiments.

FIG. 5 illustrates a flow chart showing a technique for generating fixed topic suggestion from search queries in accordance with some embodiments.

FIG. 6 illustrates a flow chart showing a technique for generating free form topic suggestion from search queries in accordance with some embodiments.

FIG. 7 illustrates a flow chart showing a technique for synthesizing a target document for purposes of generating topic inference from browsing histories in accordance with some embodiments.

FIG. 8 illustrates a flow chart showing a technique for generating a probability of topics from browsing histories in accordance with some embodiments.

FIG. 9 illustrates a bar chart diagram showing an example list of probability distribution of topics.

FIG. 10 illustrates a flow chart showing a technique for generating a prediction of topics from user interactions in accordance with some embodiments.

FIGS. 11A-11G illustrate examples of various screen displays that can be generated by a mobile personalization application on a user's mobile device in conjunction with the personalization modeling and content recommendation server.

FIG. 12 is a high-level block diagram showing an example of processing system in which at least some operations related to the generation of the disclosed quick legend receipt(s) can be implemented.

### DETAILED DESCRIPTION

Various examples of the present disclosure are now described. The following description provides specific details for a thorough understanding and enabling description of these examples. One skilled in the relevant art will understand, however, that the embodiments disclosed herein may be practiced without many of these details. Likewise, one skilled in the relevant art will also understand that the present embodiments may include many other obvious features not described in detail herein. Additionally, some well-known methods, procedures, structures or functions may not be shown or described in detail below, so as to avoid unnecessarily obscuring the relevant description.

The techniques disclosed below are to be interpreted in their broadest reasonable manner, even though they are being used in conjunction with a detailed description of certain specific examples of the present disclosure. Indeed, certain terms may even be emphasized below; however, any terminology intended to be interpreted in any restricted manner will be overtly and specifically defined as such in this Detailed Description section.

References in this description to “an embodiment,” “one embodiment,” or the like, mean that the particular feature, function, structure or characteristic being described is included in at least one embodiment of the present invention. Occurrences of such phrases in this specification do not necessarily all refer to the same embodiment. On the other hand, the embodiments referred to also are not necessarily mutually exclusive. Each of the modules and applications described herein may correspond to a set of instructions for performing one or more functions described above and the methods described in this application (e.g., the computer-implemented methods and other information processing methods described herein). These modules (e.g., sets of instructions) need not be implemented as separate software programs, procedures or modules, and thus various subsets of these modules may be combined or otherwise rearranged (e.g., from the server side to the client side) in various embodiments.

It is observed that there is the aforementioned need of having a tool that effectively addresses the information overload, that reduces the time necessary to siphon out undesirable information, and that increases the ease of locating relevant or interesting information. Conventional approaches may need human supervision and/or extensive training. Therefore, it is also beneficial if such tool needs only a minimum amount of time in training and initiating, and if such tool can operate without human intervention or supervision.

Accordingly, disclosed herein are techniques for automatically performing topic and interest based content recommendation for mobile devices, which can help the users of mobile computing devices (e.g., smart phones) discover more of the information they want by delivering educated recommendations that are personalized to their interests, in ways that are more natural and comprehensible.

More specifically, in some embodiments, techniques described herein include a topic and interest based content recommendation system, which may include several components, such as an automated recommendation server for content available on the Internet (e.g., webpages, applications, and events), and a mobile personalization application which may retrieve various types of data and user inputs from a mobile device, and may present content recommendation to the user (e.g., upon receiving such recommendation from the server). The automatic topic and interest based content recommendation system is designed to provide high quality, interesting and dynamic, constantly updating content suggestions to a user with minimal explicit user input, curation or specific feedback, while maximizing the likelihood that the user may be interested in and view the content suggested by the system.

### System Overview

Various aspects of the automatic topic and interest based content recommendation system are introduced in more detail below. As a general overview, some examples of these aspects include:

(1) New User Topic Subscription Onboarding with Cold Start Topic Inference Engine:

Conventional news and article discovery systems may either rely on an opaque personalization engine or collaborative filtering system, or may require users to manually curate a list of topics that the users are interested in. In contrast, the introduced system can provide both the transparency of recommending content based around human-comprehensible topic descriptors, while allowing for fully or partially automated curation of user interests with a topic inference engine. Additionally, one aspect of the topic inference engine includes a “Cold Start” topic inference component, which implements techniques that can enable the system to estimate the probability of a specific user's interest in a given series of topics with no prior in-app user interactions.

(2) Topic Management with Iterative Topic Inference Engine Recommendations:

The “Iterative” topic inference component of the topic inference engine includes additional available inputs (as compared to the Cold Start component) including, for example, a set of topics that a user is already following (which may also be referred to herein as “direct prior topics”), as well as a list of items in the system that a user has previously viewed, shared or favorited (which may be collectively referred to herein as “application usage data.”)

Further, some embodiments of the mobile personalization application may feature a single screen for topic management, in which existing topic subscriptions can be rendered in a list, in some implementations, with recommended topics rendered in a condensed list format at the top of the screen. According to some examples, recommended topics may be tapped once, causing them to disappear from the Recommended Topics list and appear at the top of the Subscribed Topics list, from which they may be used (e.g., in a real time manner) to drive new recommended content in the user's feed. Subscribed Topics can be removed at a time desired by the user, upon which action the topic will not be recommended to the user again, depending on the embodiment.

(3) Hybrid Reverse Chronological/Interest Scoring Expandable Feed Sort:

One aspect of the system uses a specialized scoring and sorting mechanism for prioritizing content that combines a reverse chronological sort at the coarsest level, with interest and topic matching scores for finer grained sorting, combined with an expanding feed view. The top level groupings can be the most recent content, e.g., “This Hour”, then “Today” then “Yesterday”, and so on. In one or more examples, within each chronological grouping, content is not sorted on a strict basis of recency, but rather by a relevancy score derived from the quality of match to a user's list of subscribed topics, as modulated by a usage data-driven preference model (e.g., preferred sites and news sources, keywords from articles that a user has read). The result can be a highly engaging and dynamic feed of information, where the topmost elements may vary significantly over the course of an hour or a day (or a specific desired timespan of user re-engagement), while the system remains prioritizing information with the highest matching scores to a user's interest profile.

(4) News Feed Item Layout and Size Modulation by Social Media Popularity:

It is further observed that, with a conventional scrolling feed of news stories or articles on a mobile user interface, a user can become rapidly bored or overwhelmed with a large number of items, even if the items are visually differentiated and presented with rich imagery content.

In light of this problem, one aspect of the present disclosure is to modulate item sizes for the purpose of attracting a user's natural focus with varying item formats in a scrolling feed or list view. For example, in order to attract user visual attention and generate increased visual interest within a feed view (e.g., of the mobile personalization application), some embodiments may use social media popularity metrics (e.g., the number of likes or shares on various social media networks) to generate a relative popularity score for each feed item, then in some of these embodiments, the system may modulate upward the size of the highest scoring items in the feed. This can provide an additional axis of visual information, in addition to reverse chronological and interest based sorting, thereby bringing a user's attention rapidly to the most popular content in the user's feed.

(5) Content Scoring and Recommendation by Explicit Topic Matching Combined with Passive Data, Context-Based, and User Action-Based Personalization:

In yet another aspect, a content scoring and recommendation engine in the system can suggest content based on both explicit and implicit recommender factors, which may be further combined with weighting from social media popularity metrics. Explicit recommender factors may include the topic selections that have been inferred, and then approved by users as part of their topic subscription list. This list of topics may serve as the primary basis for driving content recommendations to users, in accordance with some embodiments. In addition, in some embodiments, implicit factors can be weighted into content recommendations. Implicit factors can be constructed from the users' in-app actions, as well as preferences expressed through device browsing and bookmarking history.

Note that, while the system generally provides the automatic content recommendation to the users through mobile devices in the embodiments emphasized herein, in other embodiments the users may use a computing device other than a mobile device to specify that information, such as a conventional personal computer (PC). In such embodiments, the mobile personalization application can be replaced by a more conventional software application in such computing device, where such software application has functionality similar to that of the mobile personalization application as described herein.

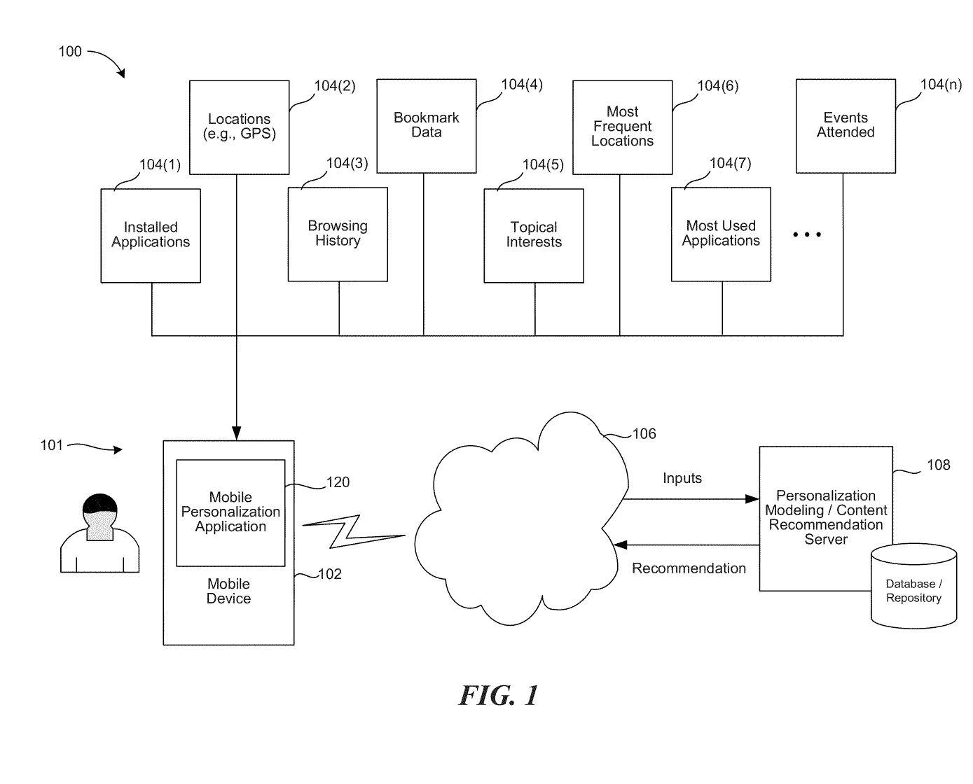

FIG. 1 illustrates an environment 100 within which the content recommendation system introduced here can be implemented. The environment 100 includes a mobile device 102 of a user 101. The mobile device 102 can be, for example, a smart phone, tablet computer, notebook computer, or any other form of mobile processing device. In some implementations, a mobile personalization application 120 can run on the user's mobile device 102 to interact with other components in the environment 100; for example, as will be described in more detail below, the mobile personalization application 120 can receive a suggested topic recommendation from the system. The environment 100 also includes a computer system 108 that implements a personalization modeling and content recommendation service (or simply “personalization recommendation server (PRS) 108”). Each of the aforementioned computer systems can include one or more distinct physical computers and/or other processing devices which, in the case of multiple devices, can be connected to each other through one or more wired and/or wireless networks. All of the aforementioned devices are coupled to each other through an internetwork 106, which can be or include the Internet and one or more wireless networks (e.g., a wireless local area network (WLAN) and/or a cellular telecommunications network).

Optionally and not illustrated for simplicity, the environment 100 can further include a third-party application's server system, which may provide content and/or access interest profiles (e.g., through an application programming interface (API)) that are established by the PRS 108.

In general, the PRS 108 together with the mobile personalization application 120 can facilitate the process of turning a user's readily available data 104 into a topical interest map of the user. Some examples of the readily available data 104 include installed applications 104(1), locations 104(2), browsing history data 104(3), bookmark data 104(4), topical interests 104(5), most frequent locations 104(6), most used applications 104(7), events attended 104(n), and so forth. As illustrated in FIG. 1, the mobile personalization application 120 can enable the collection of the data on the mobile device 102 (including e.g., browsing history 104(3) and bookmark data 104(4)), and the PRS 108 can correlate those data with place and topical interest information in a shared database to provide inputs to the automated content recommendation system in the PRS 108.

### Mobile Personalization Application

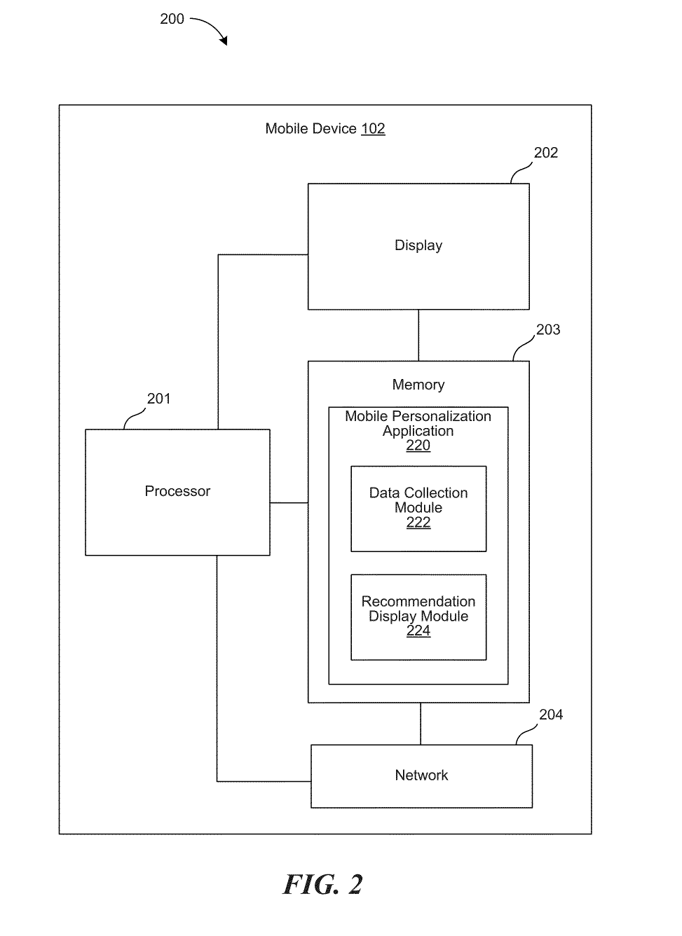

FIG. 2 illustrates an abstract functional diagram 200 showing an embodiment of the user's mobile device 102 implementing one or more techniques disclosed herein. Note that the components shown in FIG. 2 are merely illustrative; certain components that are well known are not shown for simplicity. Referring to FIG. 2, the mobile device 102 includes a processor 201, a memory 203 and a display 202. The mobile device 102 typically also includes one or more network circuits 204, such as a wireless local area network (WLAN) circuit. The processor 201 can have generic characteristics similar to general purpose processors or may be application specific integrated circuitry that provides arithmetic and control functions to the mobile device 102. The processor 201 can include a dedicated cache memory (not shown for simplicity). The processor 201 is coupled to all modules 202-203 of the mobile device 102, either directly or indirectly, for data communication.

The memory 203 may include any suitable type of storage device including, for example, an SRAM, a DRAM, an EEPROM, a flash memory, latches, and/or registers. In addition to storing instructions which can be executed by the processor 201, the memory 203 can also store data generated from the processor module 201. Note that the memory 203 is merely an abstract representation of a generic storage environment. According to some embodiments, the memory 203 may be comprised of one or more actual memory chips or modules. The display 202 can be, for example, a touchscreen display, or a traditional non-touch display (in which case the mobile device 102 likely also includes a separate keyboard or other input devices).

The network circuitry 204 can be wireless communication circuitry that can form and/or communicate with a computer network for data transmission among electronic devices such as computers, telephones, and personal digital assistants.

A mobile personalization application 220 may be or include a software application, as henceforth assumed herein to facilitate description. As such, the mobile personalization application 220 is shown as being located within the memory 203. Alternatively, the mobile personalization application 220 could be implemented as a part of a hardware or a firmware component (which may include a mobile personalization software application).

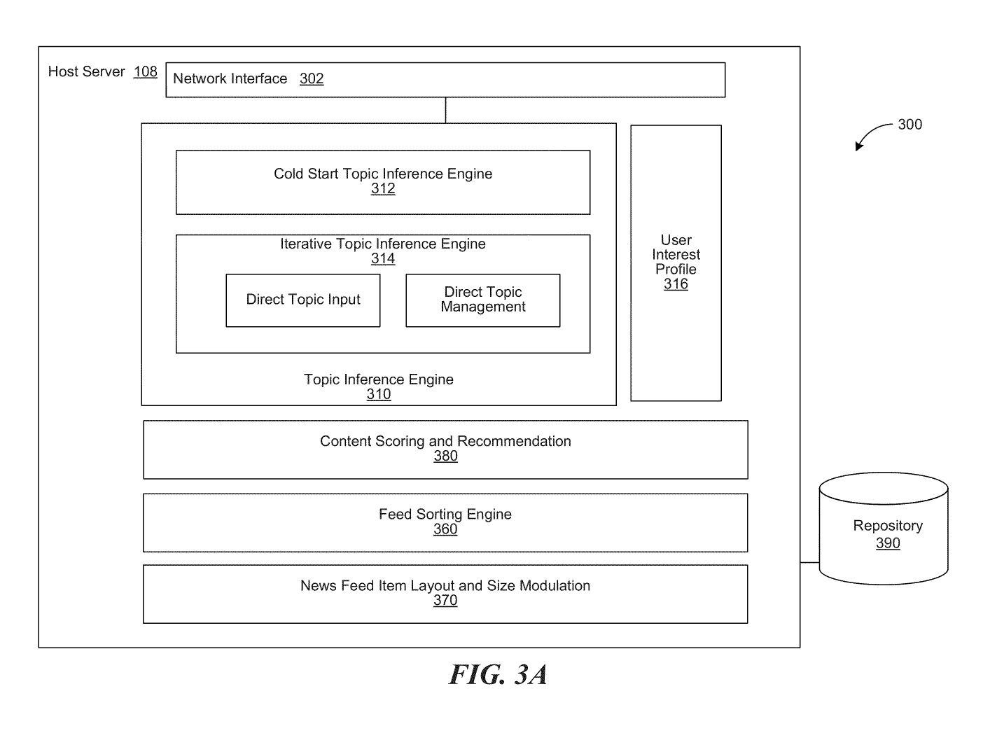

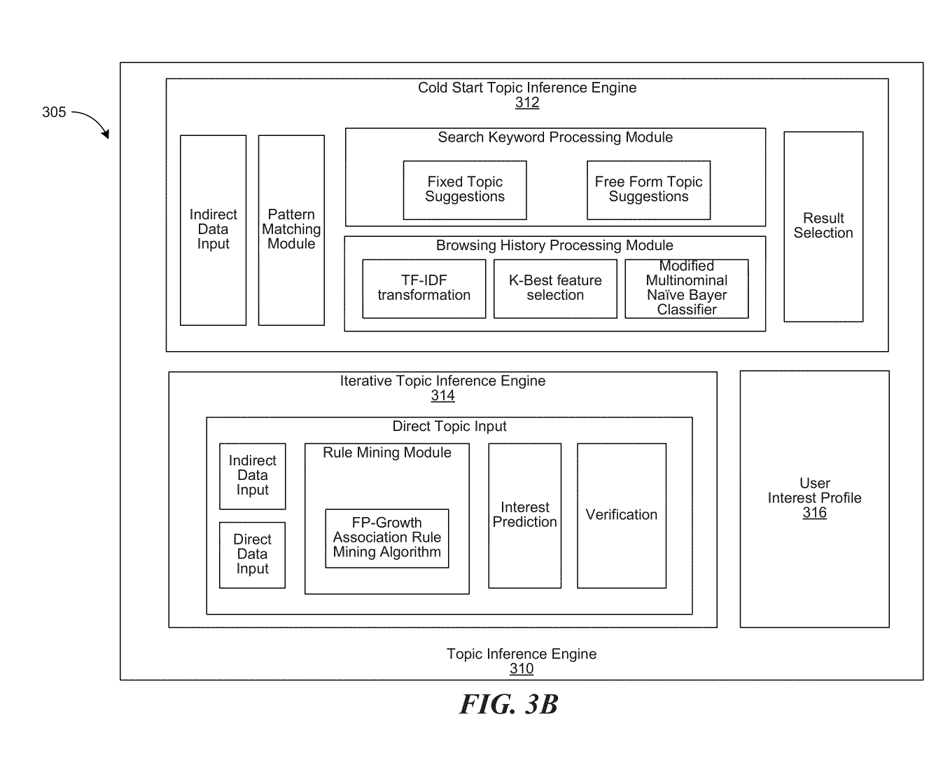

As used herein, in relation to FIGS. 2, 3A and 3B for example, a “module,” a “manager,” an “agent,” a “tracker,” a “handler,” a “detector,” an “interface,” or an “engine” includes a general purpose, dedicated or shared processor and, typically, firmware or software modules that are executed by the processor. Depending upon implementation-specific or other considerations, the module, manager, tracker, agent, handler, or engine can be centralized or its functionality distributed. The module, manager, tracker, agent, handler, or engine can include general or special purpose hardware, firmware, or software embodied in a computer-readable (storage) medium for execution by the processor.

In accordance with some embodiments of the techniques introduced here, the personalization application 220 includes a data collection module 222 and a recommendation display module 224. The data collection module 222 implements the techniques introduced here and collects data 104 on the mobile device 102. In some embodiments, the data collection module 222 can also receive inputs from the user (e.g., direct interested topics as identified by the user, or user in-app behaviors such as user's interaction with a recommended feed). The data collection module 222 can communicate with the PRS 108 via the network circuit 204. The recommendation display module 224 can receive topic recommendation and/or web content from the PRS 108.

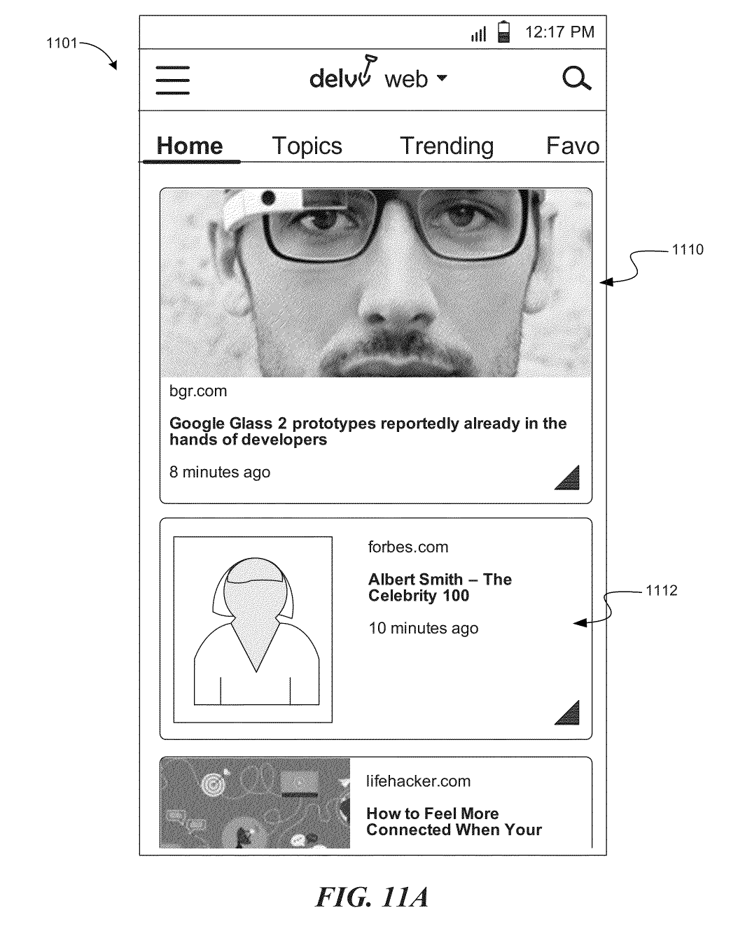

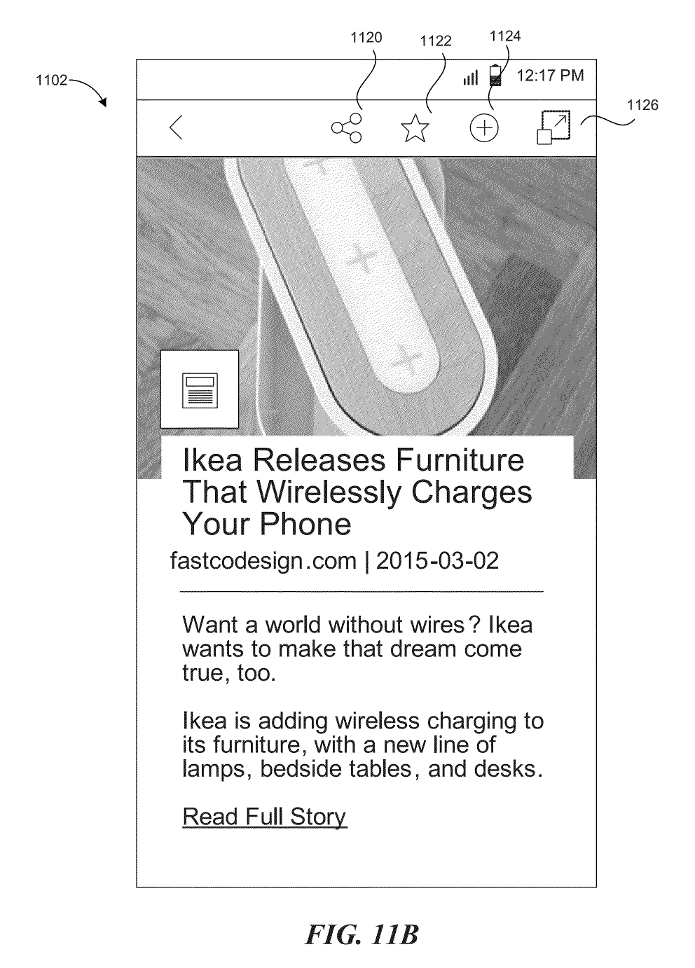

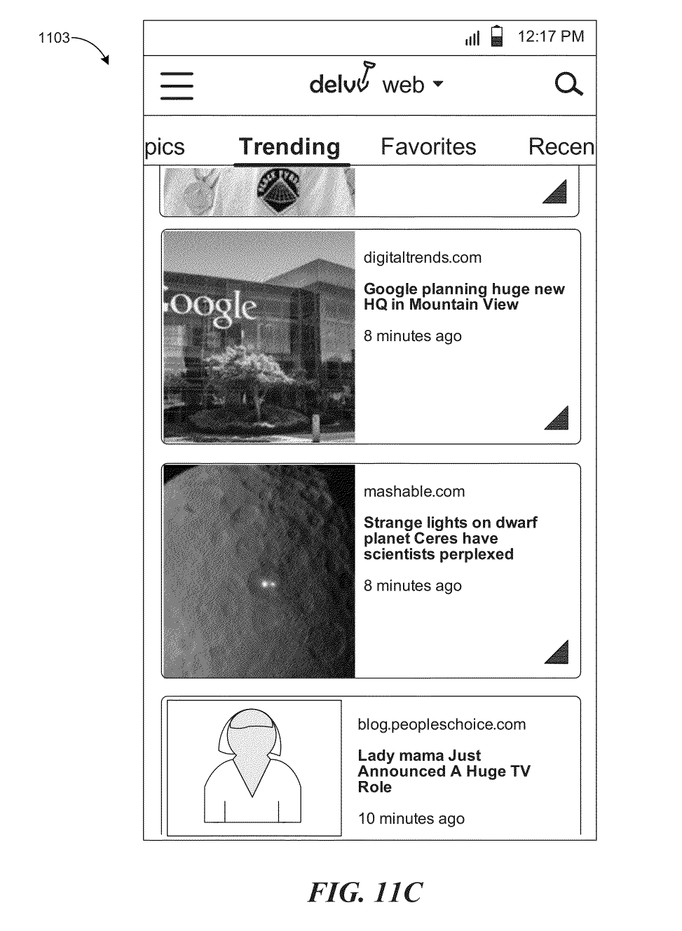

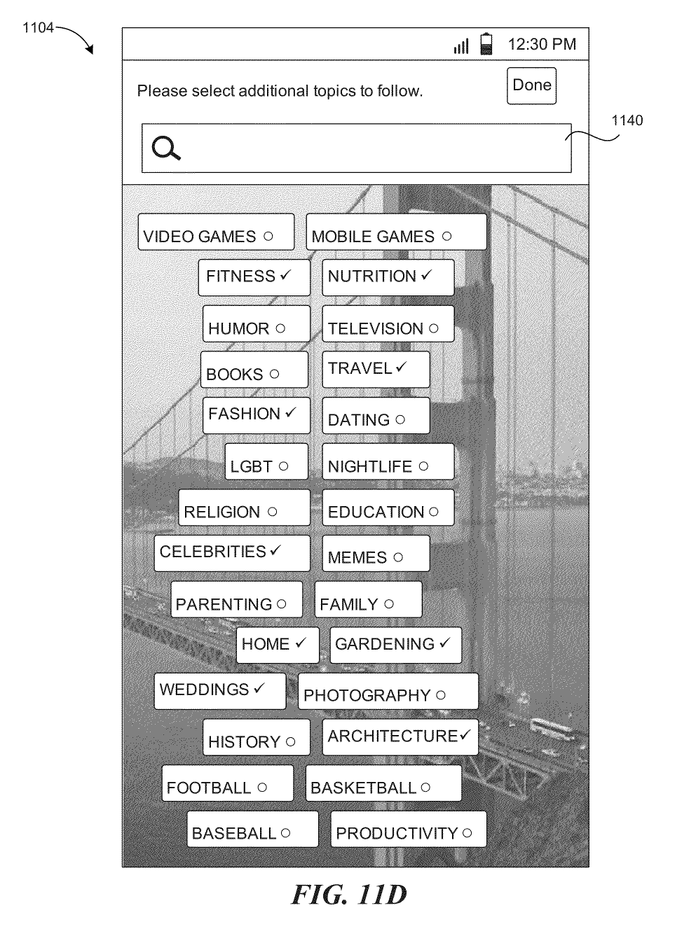

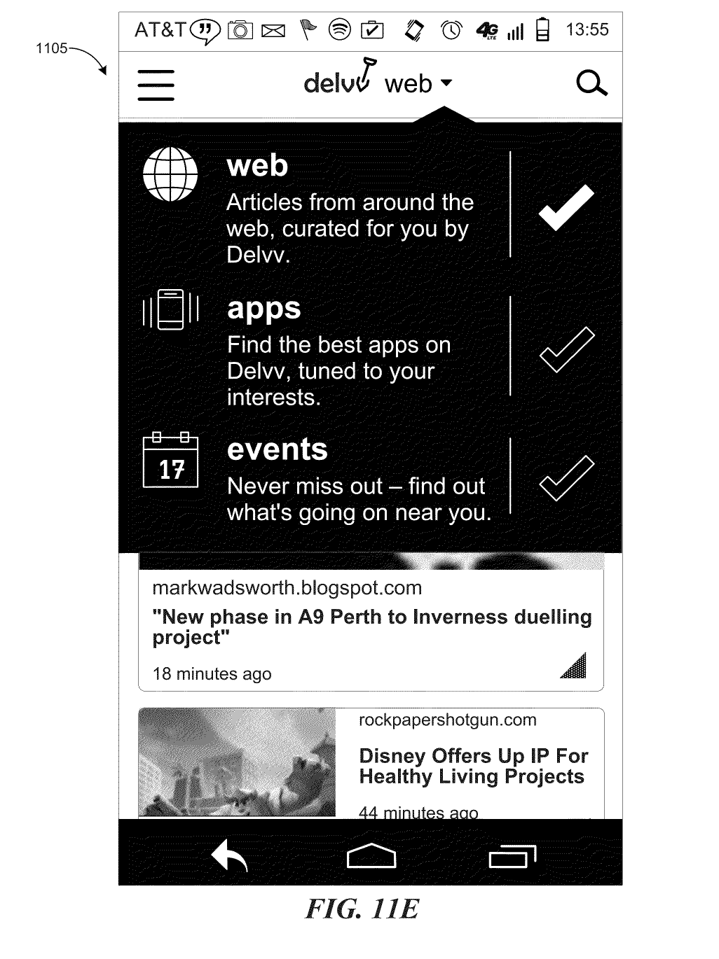

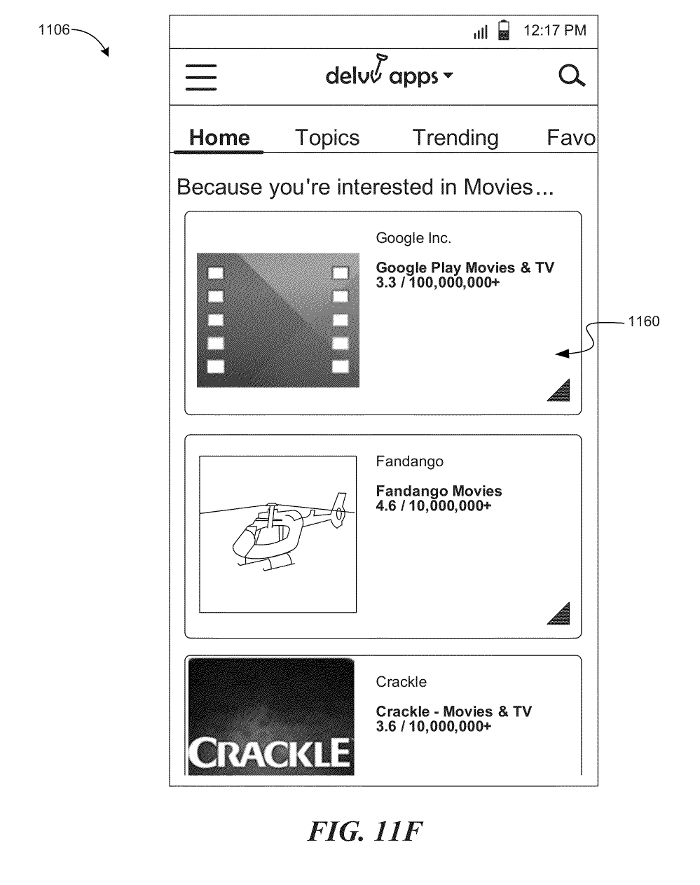

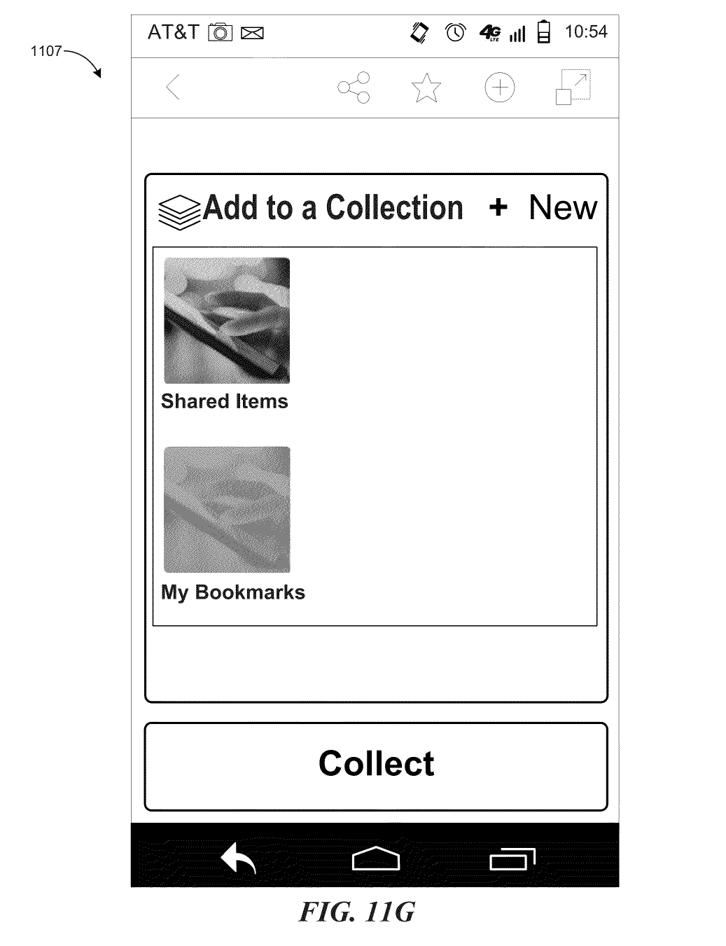

An example content feed interface 1101 is shown in FIG. 11A that includes a first content feed 1110 and a second content feed 1112. The content feeds 1110 and 1112 are example content feeds that are generated by the PRS 108, which determines that the user 101 is likely to be interested in these content feeds based on the techniques described below. According to the present embodiments, these content feeds 1110 and 1112 can be generated even prior to the user 101 first uses the mobile personalization application 120. The user 101 can interact with the content feeds, such as clicking on one of the content feeds, indicating that the user 101 might be interested in the content feed. Alternatively, the user 101 can interact with the content feeds by swiping away (e.g., a swipe left or right gesture) the content feed, indicating that the user 101 might not be interested in the content feed. If the user 101 clicks on the content feed displayed in the interface 1101, the mobile application 120 brings the user 101 to an interface 1102, shown in FIG. 11B. Via the interface 1102, the mobile application 120 enables the user 101 to read an abstract or a redacted version of the content feed so as to ensure his or her interest in the feed. The interface 1102 also allows the user 101 to further interact with the content feed, such as share with another via button 1120, mark the content feed as favorite via button 1122, add to a user's personal collection via button 1124 (which brings the user 101 to interface 1107, shown in FIG. 11F), or access the full content via button 1126. The PRS 108 may also generate content feeds further based on what is currently trending on the Internet. Example of such interface is shown in FIG. 11C as interface 1103.

The mobile personalization application 120 may also display a number of topics that have been determined, through the techniques introduced here, by the PRS 108 as topics that the user 101 may be interested in as topic suggestions. These topics can be displayed through interface 1104, shown in FIG. 11D. Further, the interface 1104 allows the user 101 to directly identify which topics are of his or her interest (e.g., by clicking to select/unselect a given topic), as well as directly search for a topic of interest by inputting the topic in a search box 1140.

All the above described user in-app interactions with the content feeds, as well as the user's explicitly selected topics of interest and the user's preference settings, can be captured and/or recorded by the data collection module 222. These data are transmitted to the PRS 108, which can be used (e.g., by the iterative topic inference engine, discussed further below) to generate and/or refine content recommendation.

In some embodiments, the mobile personalization application 120 may allow the user 101 to adjust the category of content suggestion, such as via interface 1105 shown in FIG. 11E. For example, as illustrated in FIG. 11E, the user can change the content feeds to be web articles, mobile software applications, or events that may be nearby the user 101. An example of the content feed interface with the category of content feed being changed from web articles (e.g., as shown in FIG. 11A) to mobile software applications are shown in interface 1106 of FIG. 11F, where a mobile software application is displayed as a content feed 1160.

Further details on how various embodiments of the mobile personalization application 220 operate together with the PRS 108 in implementing the automated topic and interest based content recommendation techniques disclosed here are discussed below.

### Personalization Modeling and Content Recommendation System

FIGS. 3A and 3B illustrate abstract functional diagrams 300 and 305 showing various components in an embodiment of a personalization modeling and content recommendation server (PRS) 108 in accordance with some embodiments. The host server 108 can include, for example, a network interface 302, a topic inference engine 310, a feed sorting engine 360, a news feed item layout and size modulation engine 370, and a content scoring engine 380. The various engines are implemented in the PRS 108 for performing one or more of the techniques disclosed here. Additional or less components/modules/engines can be included in the host server 108 and each illustrated component.

The network interface 302 can be a networking module that enables the host server 108 to mediate data in a network with an entity that is external to the host server 108, through any known and/or convenient communications protocol supported by the host and the external entity. The network interface 302 can include one or more of a network adaptor card including, for example, an Ethernet card, or a wireless network interface card (e.g., a WiFi card, or a mobile data card). The host server 108 may be coupled to a repository 390 for data storage purposes. The repository 390 may be one or more local hard disk drive, an array of storage disks, or a distributed data storage system.

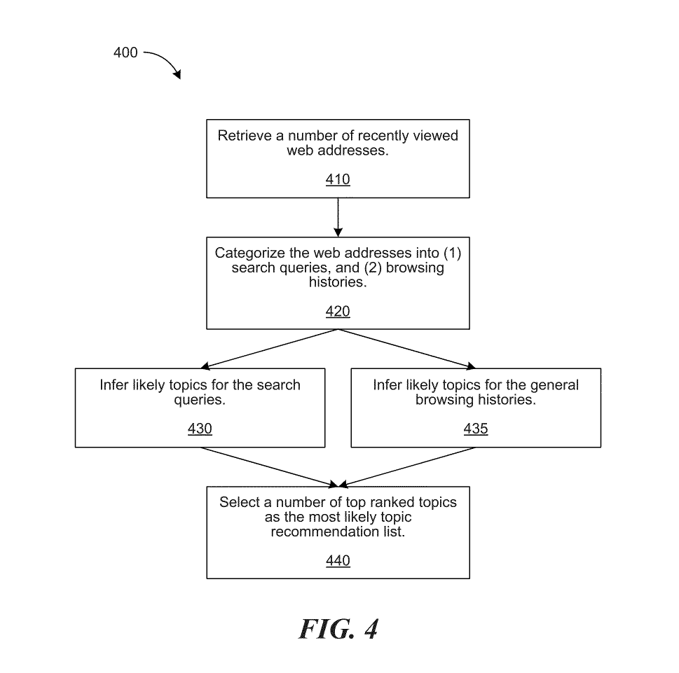

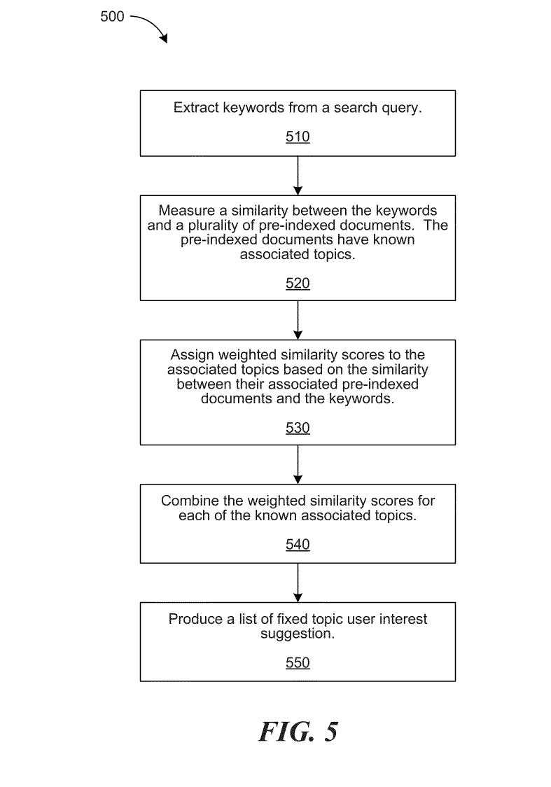

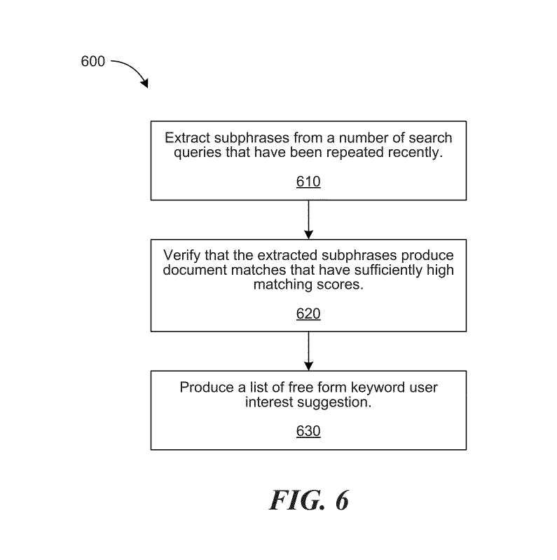

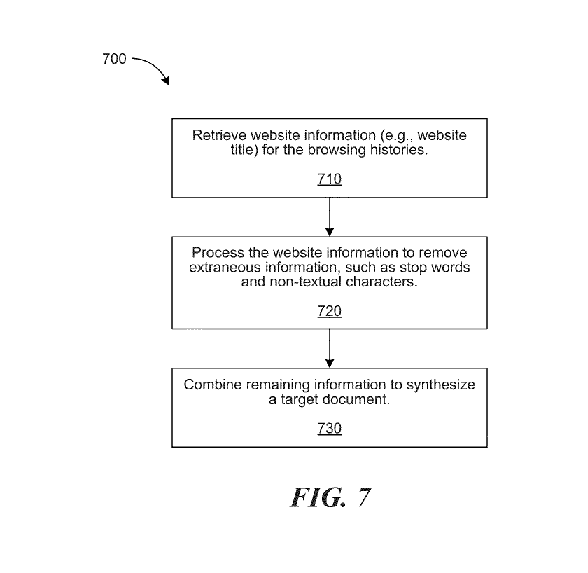

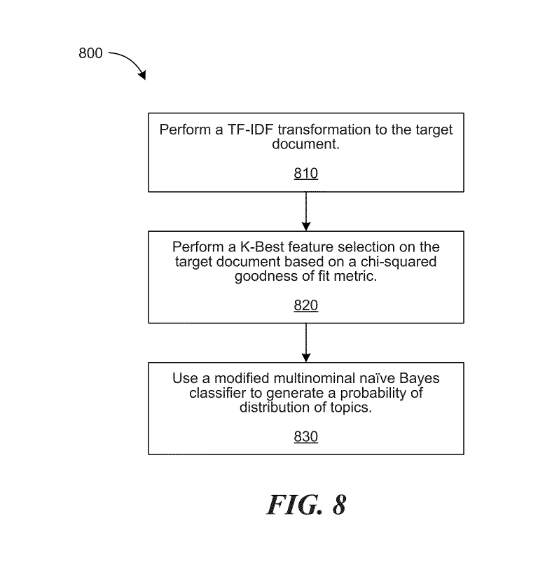

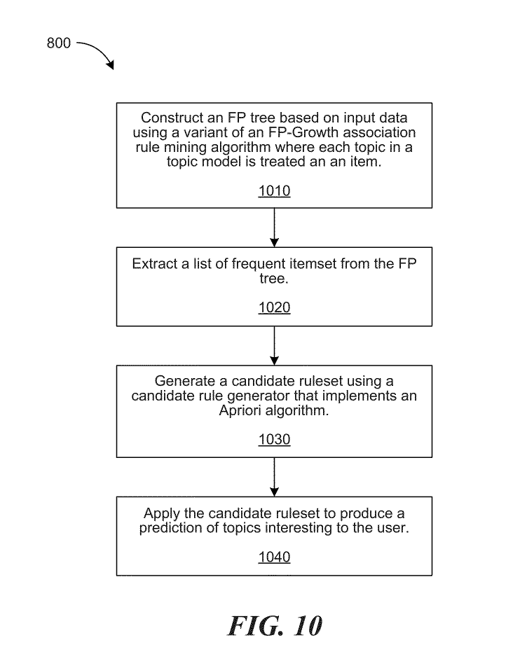

FIGS. 4-8 and 10 are flow diagrams illustrating various examples of processes (e.g., to be executed by the PRS 108) for automatically providing topic and interest based content recommendation to the user 101 of the mobile devices 102. FIGS. 11A-11G illustrate examples of various screen displays that can be generated by the mobile personalization application 120 on the mobile device 102. For purposes of facilitating the discussion, the processes of FIGS. 4-8 and 10 and the screen displays of FIGS. 11A-11G are explained with reference to certain elements illustrated in FIGS. 3A and 3B.

### Topic Inference Engine

The topic inference engine 310 can be used to solve two problems. First, given a new user to the system, what set of topics would a user most likely be interested in following? Second, given an existing user following a set of topics, what additional topics would the user be most likely to want to follow? It is observed here that these two closely related problems are important to the new user onboarding process, and are closely linked to increasing user interest in content recommendations and resulting user engagement. As such, the system introduced here addresses these problems in order to generate items that can maximize the value to a user, which in turn increases the system's ability to monetize a mobile application user base.

As illustrated in more detail in FIG. 3B, the topic inference engine 310 consists of two main components, a cold start topic inference engine 312 and an iterative topic inference engine 314. Generally speaking, the cold start topic inference engine 312 is tasked with estimating the probability that a user is interested in a given series of topics with no prior in-app user interactions. The iterative topic inference engine 314 has additional available inputs to it (as compared to the cold start topic inference engine 312) including the set of topics that a user is already following (or simply “direct prior topics”), as well as the list of items in the system that a user has previously viewed, shared or favorited (or “application usage data”).

These two engines 312 and 314 can work in concert with each other. The cold start topic inference engine 312 is useful during the new user onboarding process to prepopulate a list of topical interest areas for a user. With the techniques disclosed here, this process can be performed with no incremental user effort required. By eliminating the requirement for manual user curation of an initial topic list, the present embodiments significantly reduce the barrier to accessing a personalized news or information feed, while still presenting the user with a human-readable and comprehendible list of topic areas that the user may, optionally, edit, remove from, or add to.

### Cold Start Topic Inference Engine

In some embodiments, the cold start topic inference engine 312 can be utilized when the user 101 has not started using the system yet—in that case, the only inputs available are indirect data inputs, such as the historical browsing 104(3) and bookmark data 104(4), or a list of currently installed apps 104(1) on the mobile device 102. Note that, generally these data sets are readily available to a mobile application on commonly-seen mobile operating platforms. Furthermore, the cold start topic inference engine 312 needs to produce a reasonably accurate set of topical recommendations in a very short period of time, because the new user onboarding process cannot be a prolonged affair, lest the user lose interest before receiving any useful information from the system. As such, in some embodiments, the system should be designed to take no more than 2-3 seconds from the initial launch of the application 120, transmitting any needed data to the server 108, the server 108 processing the data, to the server 108 returning a sorted set of topic recommendations.

Specifically, in one or more implementations, when the application 120 starts, the application 120 transmits one or more sets of readily-available data 104 to the server 108. In one example, the application 120 may collect the browsing history data 104(3) that includes all most recently visited web addresses (e.g., uniform resource locators (URLs). Before the transmission of data, the data collection module 222 may perform pruning of the set of data to be transmitted from the mobile device 102 and the server 108 to the most recently visited web addresses. In some embodiments, a number in the range of 50 provides a good balance between breadth of coverage and terseness of data. Additionally or alternatively, the set of data may include bookmark data 104(4) and application install data 104(1), and in some other embodiments, other sets of data among data 104. As observed by the present disclosure, data volume of bookmark and application install data is generally smaller, and therefore may not need pruning in some implementations. After reducing the data volume, the data is transmitted to the server 108.

When the server 108 receives (410) the data, the cold start topic inference engine 312 begins by using a pattern matching module to separate (420) the browser history data into at least two subsets—search queries and general browsing histories. That is to say, the pattern matching module separate the search queries from general browsing histories. In accordance with one or more implementations, the pattern matching module can identify the search queries by a format common to one of the popular search engines including, for example, URL formats for Google™, Bing™ and Yahoo™ search queries.

Thereafter, a search keyword processing module can infer (430) likely topics from the search queries. There can be two parts for this inference process, one generating fixed topic suggestions, the other one generating free-form topic suggestions.

For the fixed topic suggestions, the search keyword processing module first extracts (510) the original search phrases from all search query URLs. These search phrases are passed through a keyword processing core (not shown for simplicity) included in the search keyword processing module to measure (520) a similarity between the keywords and a plurality of pre-indexed documents. Each of the pre-indexed documents includes one or more known associated topics.

In some embodiments, the keyword processing core is pre-trained on a large corpus of search queries in order to match query phrases and keywords with topics in a structured topic model. In one or more implementations, the keyword processing core may be trained in a fully unsupervised learning environment by utilizing a search engine (which may be internal of the server 108) and a known-good set of keywords for each topic to generate a corpus of documents related to each of the fixed topic model topics in the system. Then, each document in the corpus is transformed by stripping stop words and mapping into a word-document co-occurrence matrix. This word-document co-occurrence matrix is then converted into a globally weighted term frequency-inverse document frequency (TF-IDF) matrix. This globally weighted TF-IDF matrix can then be converted into a large matrix similarity index model, allowing quick indexing from keywords or phrases to most similar documents (e.g., on a TF-IDF basis). This trained model (including, e.g., known topics for each document, document word vectors, word-document co-occurrence matrix, and TF-IDF matrix) can be saved to storage 390 and reused as needed, because retraining is a relatively time consuming process.

The search keyword processing module then assigns (530) weighted similarity scores to those topics that are associated with the top several similar documents, thereby giving a most likely topic for each search query. Some embodiments of the search keyword processing module is configured that, if the search query does not exceed a certain similarity threshold score to any of the documents in the training corpus, then the search query is ignored for the purposes of topic inference.

The search keyword processing module iterates the above-said processes over all the known recent search queries for a given user, thereby generating similarity scores for all the fixed topics. The search keyword processing module then combines (540) all the weighted similarity scores for each of the known topics, giving an effective probability of user's interest in each topic. These calculated probabilities can be sorted and in descending order, by the search keyword processing module to produce (550) a most likely list of fixed topics of the user's interest, given the user's search query history.

In addition, search queries can be used by the search keyword processing module in a filtered form to suggest free-form topic keywords that may be of interest to the user. To generate the free-form topic suggestions. In some examples, the search keyword processing module can extract (610) subphrases (which may be individual words, bigrams and/or trigrams) from a user's search query history that have been repeated multiple times in a recent time window. For purposes of discussion herein, bigrams are combinations of two words, and trigrams are combinations of three words. Many embodiments also provide that the extraction step 610 is performed with the exclusion of a fixed list of stop words.

Next, the search keyword processing module can process these extracted subphrases to verify (620) that they produce valid, sufficiently high scoring document matches. For example, the verification can be performed by a system's internal search engine, which may perform searches in a known, confined and controlled environment. Those subphrases that do not generate sufficiently high scoring document matches may be eliminated. Those subphrases that do generate sufficiently high scoring document matches can be used by the search keyword processing module to produce (630) a list of free-form keyword user interest suggestion.

According to some embodiments, the free form keyword suggestions can be combined with the fixed topic suggestions. As an addition or an alternative, these suggestions can as well be combined with the output of the browsing history processing module, further described below.

Referring back to step 420, after the pattern matching module separates the search queries from the general browsing histories, a browsing history processing module can infer (435) likely topics from the general browsing histories.

Specifically, in some embodiments, the browsing history processing module can first synthesize a target document based on the general browsing histories. In a certain implementation, the browsing history processing module iterates over the website for each visited URL to retrieve (710) website information (e.g., website title information) for the browsing histories. Further, the browsing history processing module can process the retrieved website information to remove (720) extraneous information. Example of such extraneous information may include stop words and non-textual characters. Then, the browsing history processing module combines (730) the remaining information into a synthetic document. It is noted that this transformation effectively maps the classification problem from the document space into the user space.

With the target document, the browsing history processing module can use a browsing history processing core (not shown for simplicity) included in the browsing history processing module to create a probability distribution of topics of the target document. Specifically, according to some aspects of the present disclosure, the synthetic document is passed into the browsing history processing core, which can include, for example, three components: (1) a TF-IDF transformation component, (2) a K-Best feature selection component which is based on a chi-squared goodness of fit metric, and (3) a Multinomial Naive Bayes classifier component, implemented so as to output the full probability distribution of classifications (as opposed to merely the most likely classification). With the three components, the browsing history processing module can perform (810) a TF-IDF transformation to the target document. Next, the browsing history processing module can perform (820) a K-Best feature selection on the target document based on a chi-squared goodness of fit metric. Afterward, the browsing history processing module uses (830) the modified multinominal naïve Bayes classifier to generate a probability of distribution of topics of the target document.

Note that, the implementation of the K-Best feature selection module should be able to identify a subset of keyword features that are sufficient to distinguish documents by topic. A preferred number of features to use is a function of the number of topics being modeled, but should be at least on the order of one magnitude greater than the number of topics available in the system to allow for sufficient topical differentiation. In one example, K can be selected to be around 500 for a fixed topic list of approximately 50 topics.

As stated, the classifier component can be a multinomial naïve Bayes classifier, which can sum conditional probabilities of document classification based on each constituent document feature selected by the previous K-Best selector component. In some embodiments, the classifier is pre-trained on a large set of website title data. According to some embodiments, during this training, selections may be performed in an unsupervised manner; for example, unsupervised training can be performed by using a search engine, with known-good keywords for a given topic, to generate training set data of article titles. In this manner, the classifier can be trained in a completely unsupervised environment. It should be noted that, due to the potentially dynamic nature of content, it may be preferable to perform the training process periodically. Also, the training process can be refined by taking as additional inputs user corrections of misclassified documents.

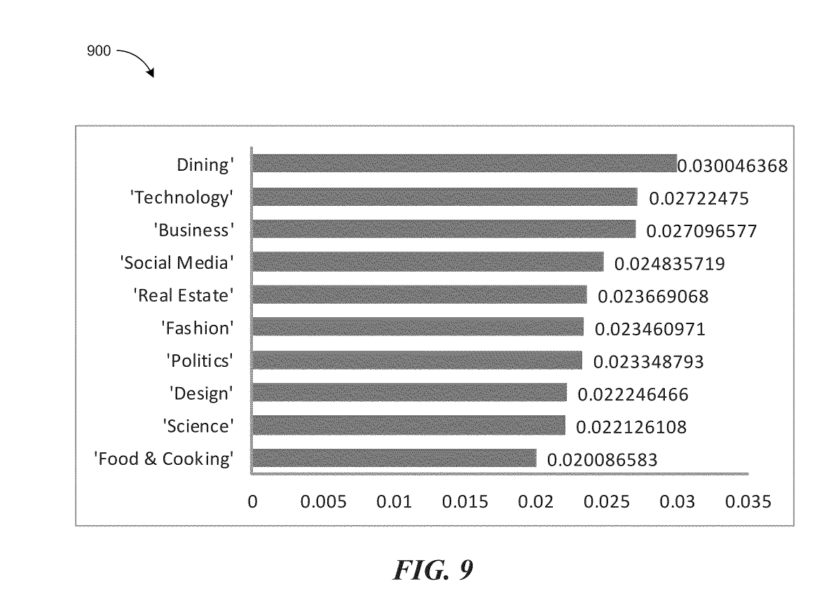

After the probability distribution of topics for the given synthetic document is produced by the classifier component, the topics can be sorted in descending order by probability, and in some embodiments, the most probable classifications for the synthetic document may be treated as the most likely topic recommendations. An example of the probability distribution of topics for a synthetic document is illustrated in FIG. 9.

In some embodiments, after generating at least one or more of a list of fixed topic suggestions, a list of free-form topic suggestions, and a probability distribution of topics, the cold start topic inference engine 312 can utilize a result selection module to select (440) the best results as the most likely topic recommendation list. For example, some embodiments may select only the top level topic hierarchy in the system (approximately 50 top level topics), and/or select no more than 20% of the available topics (e.g., approximately 10 of the highest scored topic suggestions in the top level topic domain) to ensure a significant degree of subjective accuracy in top level topic recommendations. The selected topic may then be used to generate content feeds as well as topic suggestions to the user 101 of the mobile application 120.

### Iterative Topic Inference Engine

The iterative topic inference engine 314 is the second main component of the topic inference engine 310. Because the iterative topic inference engine 314 is to operating continuously during normal operation, the inputs for the iterative topic inference engine 314 may include, in addition to the inputs only available for the cold start topic inference engine 312 (which are labeled as “indirect data input” in FIG. 3B), a set of direct prior topics as well as in-application usage data (which are labeled as “direct data input” in FIG. 3B). As previously mentioned, direct prior topics are topics that directly identified by the user as interested (e.g., via the interface 1105, FIG. 11E). In-application usage data can be recorded from the user interactions with the content feed (which is generally discussed above with respect to FIGS. 11A-11G). These data are “direct data input” because the user inputs them directly, as opposed to those “indirect data input” that are inferred from user's past behaviors (e.g., data 104).

In order to increase the accuracy of predicting topic interests, a strong indicator is the set of other topics that has already been selected by the user to follow. The embodiments introduced here recognize that, because a hierarchy of broader and narrower topics exists, and because the cold start topic inference engine 312 enables the system to suggest a set of top level topics in the cold start case, there are subtopics of certain top level topics (e.g., either selected by the user manually or determined by the PRS 108) that the user is significantly more likely to be interested in. The embodiments herein also observed that there exists an overlapping, non-orthogonal nature of the human-described topics in any topical ontology, which can be referred to as “semantic overlap.” An example of semantic overlap is that users following “computer science” and “computer hardware” are more likely to be interested in “computer security.” On the other hand, there are purely observational correlations of topical interest, such as users following “computer science” and “movies” are statistically more likely to be interested in “comic books,” though these topics are not related directly by subject matter.

With the above in mind, some embodiments of an iterative topic inference core of the iterative topic inference engine 314 can be built with an implementation of a variant of a frequent-pattern (FP)-Growth association rule mining algorithm. While the FP-Growth algorithm is commonly used to provide useful purchase predictions based on a set of prior purchases, it is observed in the present disclosure that this algorithm can be modified to capture hierarchical, semantic overlap, and purely observational correlations in topic selection, in a computationally and space-efficient manner and with desirable running time characteristics and performance.

In accordance with one or more embodiments, therefore, the iterative topic inference engine 314 implements a modified FP-Growth algorithm that treats each topic in the topic model for the system as an item. With the modified FP-Growth algorithm, the iterative topic inference engine 314 first constructs (1010) an FP tree based on the input data, which in some embodiments include both indirect and direct data inputs. The construction of the FP tree is such that each path through the tree represents an ordered set of items, which represent topic selections. Note that some implementations provide that the iterative topic inference engine 314 is pre-trained. The training data set can be built from the prior user topic selections made over the lifecycle of the system, or during a specific training period.

Next, the iterative topic inference engine 314 extracts (1020) a list of frequent itemsets from the FP tree. After the list of frequent itemsets is extracted, each frequent itemset is passed into a candidate rule generator that implements an Apriori algorithm to generate (1030) a candidate ruleset. In some embodiments, only rules that exceed a reasonable confidence threshold are kept in the candidate ruleset. Additionally, the candidate ruleset may be modulated, thereby increasing rule confidence where appropriate, to ensure that hierarchical, known topic relationships are accurately captured.

With the resulting candidate ruleset, the iterative topic inference engine 314 can apply (1040) the ruleset to any subset of the existing topic selections for a user in order to calculate the most likely following topic selections. In this way, embodiments of the iterative topic inference engine 314 can provide accurate topic interest predictions, and can be used to provide a probability-based sort for the set of all possible topic selections, thereby presenting the most likely next selections first.

Overall, it is noted that the iterative topic inference engine 314 is useful in at least two separate contexts—first, in the new user onboarding process (e.g., as soon as initial cold start topic recommendations are available) and second, in the process of suggesting new topics for a user to add to their topic subscription list.

### Hybrid Reverse Chronological/Interest Scoring Expandable Feed Sort

Referring back to FIG. 3A, the feed sorting engine 360 implements a feed sorting mechanism that establishes a desired balance, in an interest-driven environment, between the importance of recency and dynamic content, bearing in mind the importance of finding content that matches a user topic interest and personalization profile.

A first conventional approach to this problem includes finding all content that strictly matches a user's interest profile, utilizing an interest-based scoring strictly as a filtering mechanism, and sorting results on a strictly reverse chronological basis. This conventional approach suffers from poor match quality. A second conventional approach include applying a time-based threshold as a filter (e.g., limited to only the current day's content), then sorting feed results based on quality of match to a user's interest profile. While the second conventional approach is likely to provide better user-content match quality, it may also be inherently less dynamic, driving less engagement and interaction with the content in question.

Accordingly, the feed sorting engine 360 implements a mechanism that aims to display the best interest-based content matches first, within a given time range, while allowing for exploration backwards into less recent time frames merely by scrolling down the feed. To avoid creating an unmanageably long process of scrolling down to access content from earlier in the day, or yesterday, each subgrouping within the feed is reduced to include only the best matches. Further, each subgrouping within the feed is de-duplicated on a keyword basis and/or on an information source basis. Additionally, duplicate results and lower quality content matches can be moved into an overflow set for the given time window, which can be expanded and inserted into the feed only at a user's explicit request.

An example of the feed list generation mechanism implemented by the feed sorting engine 360, in pseudocode terms, is provided herein as follows:

//initialization of a series of time blocks in the order to
appear in the feed view
timeblocks = [″This Hour″, ″Today″, ″Yesterday″, ″This
Week″, ″Last Week″, ″This Month″, ″Last Month″]
//any reasonable sequence of time windows is possible here
feed_results = [ ]
//retrieve sorted interest matches for each timeblock
for timeblock in timeblocks:
feed_ results.append(new GroupDivider(timeblock))
//note that timeblock start and end values must not overlap
//or duplicate results will likely occur across time blocks
block_results = fetch_interest_matches(userid,
timeblock.start, timeblock.end)
//threshold for ″best quality″ matches
//dependent on normalization of scoring
cutoff = 0.75
//split results around threshold
top_results = block_results.results_above_threshold(cutoff)
bottom_results =
block_results.results_below_threshold(cutoff)
//deduplicate and add top results to main feed, then
overflow into expanded view
deduped_top_results = top_results.deduplicate( )
feed results = feed results + deduped_top_results
expanded_results = [b in top_results where not b in
deduped_top_results] + bottom_results
feed_results.append(new
Expander(timeblock, expanded_results))

Moreover, it is observed that the content feeds must be paged to the user, which is a problem that becomes more difficult in light of the expandable nature of the feed view.

As such, some examples of the feed sorting engine 360 may implement a paging mechanism that includes a step of caching a number of feed results from the processing of each timeblock used in the feed. This can ensure that only the needed timeblocks are processed to generate the correct paging window of results, as the fetch_interest_matches mechanism may be computationally expensive. This may also be useful to avoid significant server response lag, which is typically a high priority item in practice. It is noted here that expanded results are considered out of the flow of standard paging mechanism, because they are inserted into the feed only as needed.

In this way, the feed sorting mechanism in the feed sorting engine 360 enjoys the combination of at least one or more of the following features: (1) reverse chronological sorting of high level timing blocks, (2) pure interest-based scoring within each chronological block of results, (3) in-place expandability of time-block results, and (4) pageability of feed results for feed rendering performance.

### News Feed Item Layout and Size Modulation by Social Media Popularity

It is further observed in the present embodiments that another common issue with scrolling list views or feed interfaces in mobile applications is that uniformity of layout results in rapid visual boredom, and in a tendency to visually “summarize” or skip over results.

As such, some examples of the news feed item layout and size modulation engine (LSM) 370 with a mechanism for using aggregated social media popularity statistics to modulate the feed item layout format and size to increase user attention span through variation, and to draw attention to items that are inherently most likely to be shared or engaged with in a social media context. The interface 1101 illustrated such modulation, where content feed 1110 occupies a larger size than content feed 1112.

To implement this mechanism, first, a number of baseline layouts for feed items may be constructed. Some example baseline layouts include a layout with imagery in the left part of the cell (e.g., feed 1112), a layout with imagery in the right, and a largest layout with imagery on the top of the feed and textual content below (e.g., feed 1110). For purposes of facilitating the discussion herein, these layouts are referred to as layout_left, layout_right, and layout_large.

According to some embodiments, the LSM 370 can calculate, for each item in a set of results, an aggregated social media popularity metric. For example, the LSM 370 can sum the number of like actions, number of shares, and link counts across several social media networks to obtain a social actions count. In some examples, this total social actions count can be then normalized (after being scaled logarithmically) by the LSM 370 to a 0.0 to 1.0 scale, with a score near 1.0 representing the most popular items in the system.

Then, for each item to be rendered in a list view, the item score is to be evaluated by the LSM 370 to determine the correct item layout to use. In some implementations, lower scoring items can vary between the layout_left and layout_right formats, and higher scoring items can use the layout_large format. Additionally or alternatively, the item height can be switched based on the threshold scores. In one or more embodiments, items with scaled score from 0.0 to 0.3 are to use the default scale, items with scaled score from 0.3 to 0.6 are to be increased in height by 20%, and items with scaled score above 0.6 are to use the layout_large format, which may be fixed in height and may be up to 50% larger than the baseline height for the layout_left/layout_right formats, depending on the embodiment.

In this way, the layout and size modulation mechanism in the LSM 370 enjoys the combination of at least one or more of the following features: (1) calculating of an aggregate social media popularity metric for each news or content item, (2) using of social media popularity metric to switch between one of several layout formats for an item, and (3) scaling the item height in response to variation in the social media popularity metric.

Content Scoring and Recommendation by Explicit Topic Keyword Matching Combined with Passive Data, Context-Based and User Action-Based Personalization

The content scoring and recommendation (CSR) engine 380 can make use of a combination of explicit topic matching with one or more parts in the topic inference engine 310. In a conventional explicit topic matching mechanism, every item may be tagged first, either by manual user action or an automated topic tagging system, and a set of topic matched results may be determined by extracting all items matching a specific topic tag or label.

With the capabilities enabled by the topic inference engine 310, the CSR engine 380 may adapt a modified version of the aforementioned explicit topic matching mechanism. More specifically, in one or more embodiments of the content scoring engine 380, each topic a user is subscribed to can be mapped onto a set of keywords as well as to a list of information sources (i.e. domain names from URLs). The information sources can be either manually curated or automatically inferred to be related to the topic in question. In one implementation, the CSR engine 380 can be built using an in-memory indexing, search and information retrieval engine.

In some embodiments, the CSR engine 380 can perform a search query against all content items indexed over a given timeframe, using the interest keyword list combined with domain name scoring, with weight being given to both keyword matches as well as domain name matches in a combined scoring process.

In addition, this topic matching process by the CSR engine 380 can be modulated by a topic inference engine 310, which can derive, for example: (1) a set of domain source preferences from the user's in-app actions (e.g., items viewed, shared or saved in the system), (2) a set of keyword preferences from the user's in-app actions, (3) a set of domain source preferences from the user's passive browsing history data, (4) a set of keyword preferences from the user's passive browsing history data, and (5) a set of keyword preferences derived from inferred user context.

More specifically, according to one or more embodiments, each time the mobile personalization application 120 is running, the data collection module 222 may update the host server 108 of passive browsing history data, and the system may iterate over any new results to update domain name access counts. These counts can be used to generate a synthetic weighting for the given domain in question, assuming if the count is over a threshold value dependent on the total size of the browsing history data set for the user. Likewise, each article or website URL accessed can be processed by the system, with the full text retrieved by the server 108 and metadata and keywords extracted from the text in question. These keywords can be combined across all browsing history data for the user to obtain an overall set of keyword weightings.

Likewise, every time an in-app action of viewing, sharing or saving an article or item is performed by the user 101 via the mobile personalization application 120, the data collection module 222 may update the domain name and content keyword counts on the server 108, and in some embodiments, the counts are updated with greater weighting placed on explicit sharing or saving of an article as opposed to simply viewing. These domain and keyword weightings can be combined with the passive browsing history weightings described above.

Additionally or alternatively, user context may be inferred from available mobile geolocation data, time of day, and/or day of week. A context state model may, for example, include status such as “at home”, “at work”, “exercising”, “shopping”, “eating.” In certain embodiments, context need not be explicitly known, but rather can or must be inferred from the data described above, as well as common sense rules, such as in an ad-hoc scoring system. Some embodiments provide that, if the likelihood score of a certain status is over a given threshold, then the status may be considered as the current user's status. In variations, an additional set of personalization modulations to keywords and domain sources may be added to the existing personalization set.

The combined set of personalization keyword and domain scores can be added to the explicit topic matching keywords and domain scores described above, and be processed through, for example, the aforementioned in-memory search engine to generate a scored, sorted, personalized list of content recommendations for the user over the specified time period for the query.

In this way, the keyword scores and domain source scores generation mechanism of the CSR engine 380 may be desirable over the conventional mechanisms because the scores can be generated from a combination of one or more of: (1) explicit topic subscriptions, (2) passive browser history data, (3) in-app usage data, and (4) inferred user context that is processed by an information retrieval/search index system to produce a highly personalized set of content recommendations that are indexed by the system over a given time interval.

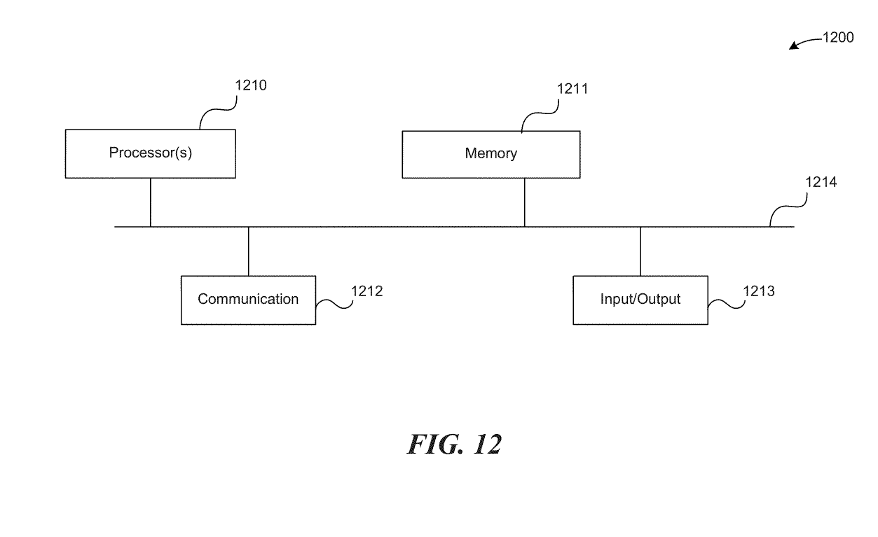

FIG. 12 is a high-level block diagram showing an example of a processing device 1200 that can represent any of the devices described above, such as the mobile device 102 or the PRS 108. As noted above, any of these systems may include two or more processing devices such as represented in FIG. 12, which may be coupled to each other via a network or multiple networks.

In the illustrated embodiment, the processing system 1200 includes one or more processors 1210, memory 1211, a communication device 1212, and one or more input/output (I/O) devices 1213, all coupled to each other through an interconnect 1214. The interconnect 1214 may be or include one or more conductive traces, buses, point-to-point connections, controllers, adapters and/or other conventional connection devices. The processor(s) 1210 may be or include, for example, one or more general-purpose programmable microprocessors, microcontrollers, application specific integrated circuits (ASICs), programmable gate arrays, or the like, or a combination of such devices. The processor(s) 1210 control the overall operation of the processing device 1200. Memory 1211 may be or include one or more physical storage devices, which may be in the form of random access memory (RAM), read-only memory (ROM) (which may be erasable and programmable), flash memory, miniature hard disk drive, or other suitable type of storage device, or a combination of such devices. Memory 1211 may store data and instructions that configure the processor(s) 1210 to execute operations in accordance with the techniques described above. The communication device 1212 may be or include, for example, an Ethernet adapter, cable modem, Wi-Fi adapter, cellular transceiver, Bluetooth transceiver, or the like, or a combination thereof. Depending on the specific nature and purpose of the processing device 1200, the I/O devices 1213 can include devices such as a display (which may be a touch screen display), audio speaker, keyboard, mouse or other pointing device, microphone, camera, etc.

### CONCLUSION

Unless contrary to physical possibility, it is envisioned that (i) the methods/steps described above may be performed in any sequence and/or in any combination, and that (ii) the components of respective embodiments may be combined in any manner.

The techniques introduced above can be implemented by programmable circuitry programmed/configured by software and/or firmware, or entirely by special-purpose circuitry, or by a combination of such forms. Such special-purpose circuitry (if any) can be in the form of, for example, one or more application-specific integrated circuits (ASICs), programmable logic devices (PLDs), field-programmable gate arrays (FPGAs), etc.

Software or firmware to implement the techniques introduced here may be stored on a machine-readable storage medium and may be executed by one or more general-purpose or special-purpose programmable microprocessors. A “machine-readable medium”, as the term is used herein, includes any mechanism that can store information in a form accessible by a machine (a machine may be, for example, a computer, network device, cellular phone, personal digital assistant (PDA), manufacturing tool, any device with one or more processors, etc.). For example, a machine-accessible medium can include recordable/non-recordable media (e.g., read-only memory (ROM), random access memory (RAM), magnetic disk storage media, optical storage media, flash memory devices, etc.).

Note that any and all of the embodiments described above can be combined with each other, except to the extent that it may be stated otherwise above or to the extent that any such embodiments might be mutually exclusive in function and/or structure.

Although the present disclosure has been described with reference to specific exemplary embodiments, it will be recognized that the techniques introduced here are not limited to the embodiments described. Accordingly, the specification and drawings are to be regarded in an illustrative sense rather than a restrictive sense.

What is claimed is:

1. A method for a computerized system to automatically recommend network-based content to a user of a mobile device regardless of whether the user has previously used the system, the method comprising:
before the user first uses the system, generating a most likely topic recommendation list by:
retrieving at least, from the mobile device, a predetermined number of web addresses of most recently visited webpages;
categorizing, by utilizing a pattern matching module, the web addresses of most recently visited webpages into at least two categories, (1) search queries, and (2) general browsing histories;
inferring likely topics based on the search queries, using a search keyword processing module, by:
for each search query: (1) extracting one or more search keywords from a given search query; (2) measuring a similarity between the one or more search keywords and a plurality of pre-indexed documents, wherein each of the pre-indexed documents has one or more known associated topics; and (3) assigning weighted similarity scores to the one or more known associated topics based on the measured similarity; and
producing a list of fixed topic user interest suggestions by combining the weighted similarity scores for each of the known associated topics;
inferring likely topics based on the general browsing histories, using a browsing history processing module, by:
synthesizing a target document based on retrieving website information for each of the general browsing histories; and
generating a probability distribution of topics of the target document; and
selecting a predetermined percentage of topics, from the list of fixed topic user interest suggestions and from the probability distribution of topics of the target document, as the most likely topic recommendation list.

2. The method of claim 1, wherein inferring likely topics based on the search queries further comprises:
extracting subphrases from the search queries that have been repeated a plurality of times in a recent period of time;
verifying, by using a search engine, that the extracted subphrases produce document matches that have matching scores exceeding a minimum threshold; and
producing a list of free form keyword user interest suggestions based on the extracted subphrases that are verified.

3. The method of claim 2, wherein selecting the predetermined percentage of topics is further based on the list of free form keyword user interest suggestions.

4. The method of claim 1, wherein inferring likely topics based on the search queries further comprises:
determining that an associated topic with the highest weighted similarity score is a most likely topic for the given search query.

5. The method of claim 1, wherein inferring likely topics based on the search queries further comprises:
discarding one or more of the pre-indexed documents if the similarity does not exceed a predetermined similarity threshold score.

6. The method of claim 5, wherein the subphrases include one or more of: an individual word, and a combination of multiple words.

7. The method of claim 1, wherein synthesizing a target document comprises:
retrieving website title information for each of the general browsing histories;
processing the website title information to remove extraneous information; and
combining remaining information into the target document.

8. The method of claim 1, further comprising:
before normal operations, training the search keyword processing module by:
generating a corpus of documents related to each of a plurality of fixed topic model topics by utilizing a search engine and a known-good set of keywords for each of the plurality of fixed topic model topics;
transforming each document in the corpus of documents by stripping stop words and mapping into a word-document co-occurrence matrix;
converting the word-document co-occurrence matrix into a globally weighted term frequency-inverse document frequency (TF-IDF) matrix;
converting the globally weighted term TF-IDF matrix into a matrix similarity index model, whereby the matrix similarity index model enables indexing from keywords to most similar documents; and
storing the matrix similarity index model.

9. The method of claim 1, wherein generating a probability distribution of topics of the target document comprises:
performing a term frequency-inverse document frequency (TF-IDF) based transformation to the target document;
performing a K-Best feature selection on the transformed target document to select one or more document features, wherein the selection is based on a chi-squared goodness of fit metric; and
based on the selected one or more document features, generating the probability distribution of topics of the target document by using a multinominal naïve Bayes classifier that is configured to output a full probability distribution of classifications.

10. The method of claim 1, further comprising:
retrieving, from the mobile device, webpage bookmark data, wherein generating the most likely topic recommendation list is further based on the webpage bookmark data.

11. The method of claim 1, further comprising:
retrieving, from the mobile device, application install data, wherein generating the most likely topic recommendation list is further based on the application install data.

12. The method of claim 1, further comprising:
during the use of the system, retrieving, from the mobile device, application usage data and a set of topics specified by the user; and
constructing a frequent pattern (FP) tree using an iterative topic inference engine based on (1) the most likely topic recommendation list generated before the user first uses the system, (2) the application usage data, and (3) the set of topics specified by the user, wherein the iterative topic inference engine is adapted to implement a variant of an FP-Growth association rule mining algorithm where each topic in a topic model is treated as an item;
extracting a list of frequent itemsets from the FP tree; and
generating a candidate ruleset by passing each frequent itemset into a candidate rule generator that implements an Apriori algorithm; and
applying the candidate ruleset to produce a prediction of most likely followed topics for the user.

13. The method of 12, further comprising:
updating the most likely topic recommendation list based on the prediction.

14. The method of claim 12, wherein only rules that exceed a predetermined confidence threshold are kept in the candidate ruleset.

15. The method of claim 12, further comprising:
modulating the ruleset to increase rule confidence so as to capture known, hierarchical topic relationships.

16. A computerized system configured to automatically recommend network-based content to a user of a mobile device regardless of whether the user has previously used the system, the system comprising a processor and a memory storing a plurality of instructions which, when executed by the processor, causes the processor to perform a method comprising:
before the user first uses the system, generating a most likely topic recommendation list by:
retrieving at least, from the mobile device, a predetermined number of web addresses of most recently visited webpages;
categorizing, by utilizing a pattern matching module, the web addresses of most recently visited webpages into at least two categories, (1) search queries, and (2) general browsing histories;
inferring likely topics based on the search queries, using a search keyword processing module, by:
for each search query: (1) extracting one or more search keywords from a given search query; (2) measuring a similarity between the one or more search keywords and a plurality of pre-indexed documents, wherein each of the pre-indexed documents has one or more known associated topics; and (3) assigning weighted similarity scores to the one or more known associated topics based on the measured similarity; and
producing a list of fixed topic user interest suggestions by combining the weighted similarity scores for each of the known associated topics;
inferring likely topics based on the general browsing histories, using a browsing history processing module, by:
synthesizing a target document based on retrieving website information for each of the general browsing histories; and
generating a probability distribution of topics of the target document; and
selecting a predetermined percentage of topics, from the list of fixed topic user interest suggestions and from the probability distribution of topics of the target document, as the most likely topic recommendation list.

17. The system of claim 16, wherein inferring likely topics based on the search queries further comprises:
extracting subphrases from the search queries that have been repeated a plurality of times in a recent period of time;
verifying, by using a search engine, that the extracted subphrases produce document matches that have matching scores exceeding a minimum threshold; and
producing a list of free form keyword user interest suggestions based on the extracted subphrases that are verified.

18. The system of claim 17, wherein selecting the predetermined percentage of topics is further based on the list of free form keyword user interest suggestions.

19. The system of claim 16, wherein inferring likely topics based on the search queries further comprises:
determining that an associated topic with the highest weighted similarity score as a most likely topic for the given search query.

20. The system of claim 16, wherein inferring likely topics based on the search queries further comprises:
discarding one or more of the pre-indexed documents if the similarity does not exceed a predetermined similarity threshold score.

21. The system of claim 20, wherein the subphrases include one or more of: an individual words, and a combination of multiple words.

22. The system of claim 16, wherein synthesizing a target document comprises:
retrieving website title information for each of the general browsing histories;
processing the website title information to remove extraneous information; and
combining remaining information into the target document.

23. The system of claim 16, further comprising:
before normal operations, training the search keyword processing module by:
generating a corpus of documents related to each of a plurality of fixed topic model topics by utilizing a search engine and a known-good set of keywords for each of the plurality of fixed topic model topics;
transforming each document in the corpus of documents by stripping stop words and mapping into a word-document co-occurrence matrix;
converting the word-document co-occurrence matrix into a globally weighted term frequency-inverse document frequency (TF-IDF) matrix;
converting the globally weighted term TF-IDF matrix into a matrix similarity index model, whereby the matrix similarity index model enables indexing from keywords to most similar documents; and
storing the matrix similarity index model.

24. The system of claim 16, wherein generating a probability distribution of topics of the target document comprises:
performing a term frequency-inverse document frequency (TF-IDF) based transformation to the target document;
performing a K-Best feature selection on the transformed target document to select one or more document features, wherein the selection is based on a chi-squared goodness of fit metric; and
based on the selected one or more document features, generating the probability distribution of topics of the target document by using a multinominal naïve Bayes classifier that is configured to output a full probability distribution of classifications.

25. The system of claim 16, wherein the method further comprises:
retrieving, from the mobile device, webpage bookmark data, wherein generating the most likely topic recommendation list is further based on the webpage bookmark data.

26. The system of claim 16, wherein the method further comprises:
retrieving, from the mobile device, application install data, wherein generating the most likely topic recommendation list is further based on the application install data.

27. The system of claim 16, wherein the method further comprises:
during the use of the system, retrieving, from the mobile device, application usage data and a set of topics specified by the user; and
constructing a frequent pattern (FP) tree using an iterative topic inference engine based on (1) the most likely topic recommendation list generated before the user first uses the system, (2) the application usage data, and (3) the set of topics specified by the user, wherein the iterative topic inference engine is adapted to implement a variant of an FP-Growth association rule mining algorithm where each topic in a topic model is treated as an item;
extracting a list of frequent itemsets from the FP tree; and
generating a candidate ruleset by passing each frequent itemset into a candidate rule generator that implements an Apriori algorithm; and
applying the candidate ruleset to produce a prediction of most likely followed topics for the user.

28. The system of 27, wherein the method further comprises:
updating the most likely topic recommendation list based on the prediction.

29. The system of claim 27, wherein only rules that exceed a predetermined confidence threshold are kept in the candidate ruleset.

30. The system of claim 27, wherein the method further comprises:
modulating the ruleset to increase rule confidence so as to capture known, hierarchical topic relationships.
